(19) United States
(12) Patent Application Publication
(10) Pub. No.: US 2016/0350707 A1
(43) Pub. Date: Dec. 1, 2016

(54) METHOD OF TRACKING AND TRACING INGREDIENTS IN A BULK HOLDING BIN

(71) Applicant: Mark K. Gaalswyk, Welcome, MN (US)

(72) Inventor: Mark K. Gaalswyk, Welcome, MN (US)

(21) Appl. No.: 15/150,959

(22) Filed: May 10, 2016

Related U.S. Application Data
(60) Provisional application No. 62/167,584, filed on May 28, 2015.

(51) Int. Cl. G06Q 10/08

(52) U.S. Cl. CPC G06Q 10/087; G06Q 10/0838

(57) ABSTRACT

A method for determining the ingredients that could possibly be in a mixture discharged from a bulk holding bin in the time interval between the times the bin is observed to be completely empty. Ingredient information is stored in a computer data base, and this information is subsequently used to track possible components in any mixture discharged from the holding bin.

### RELATED APPLICATION

Priority is hereby claimed to U.S. Provisional Patent No. 62/167,584 to Gaalswyk, filed May 28, 2015 to a Method of Tracing Ingredients in a Bulk Holding Bin, which describes the construction and use of the present invention and is hereby incorporated herein by reference in its entirety.

### BACKGROUND OF THE INVENTION

Field of the Invention

This invention relates generally to the field of materials management, and more particularly to a method of tracking and tracing ingredients in a bulk holding bin.

Description of the Related Art

In the mixing of ingredients for feed and other substances comprised of a variety of different ingredients, it is often desired to be able to track exactly what ingredients could have been possibly used in any resulting mixture of ingredients.

Often times many different truckloads of ingredients from many different sources or ingredient lot numbers are placed into one ingredient silo or container. Ingredients are then conveyed out the bottom of the silo or container by a screw conveyor, slide chute or other mechanisms into batch weighing or other weighing and mixing systems.

The problem is that the particles do not necessarily flow down through the silo in a first in—first out distribution and are really a mixture of all particles in the silo. Thus, any resulting mixture containing at least one inclusion of the contents from this ingredient silo may contain particles from a variety of different truck loads or sources.

As a consequence of the foregoing situation, there has existed a longstanding need for a new and improved method of tracking and tracing ingredients in a bulk holding bin and the provision of such a system is a stated objective of the present invention.

### BRIEF SUMMARY OF THE INVENTION

Briefly stated the present invention provides a method for determining the ingredients that could possibly be in a mixture discharged from a bulk holding bin in the time interval between the times the bin is observed to be completely empty. Ingredient information is stored in a computer data base, and this information is subsequently used to track possible components in any mixture discharged from the holding bin.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a schematic flow diagram illustrating the method of the present invention.

### DETAILED DESCRIPTION OF THE INVENTION

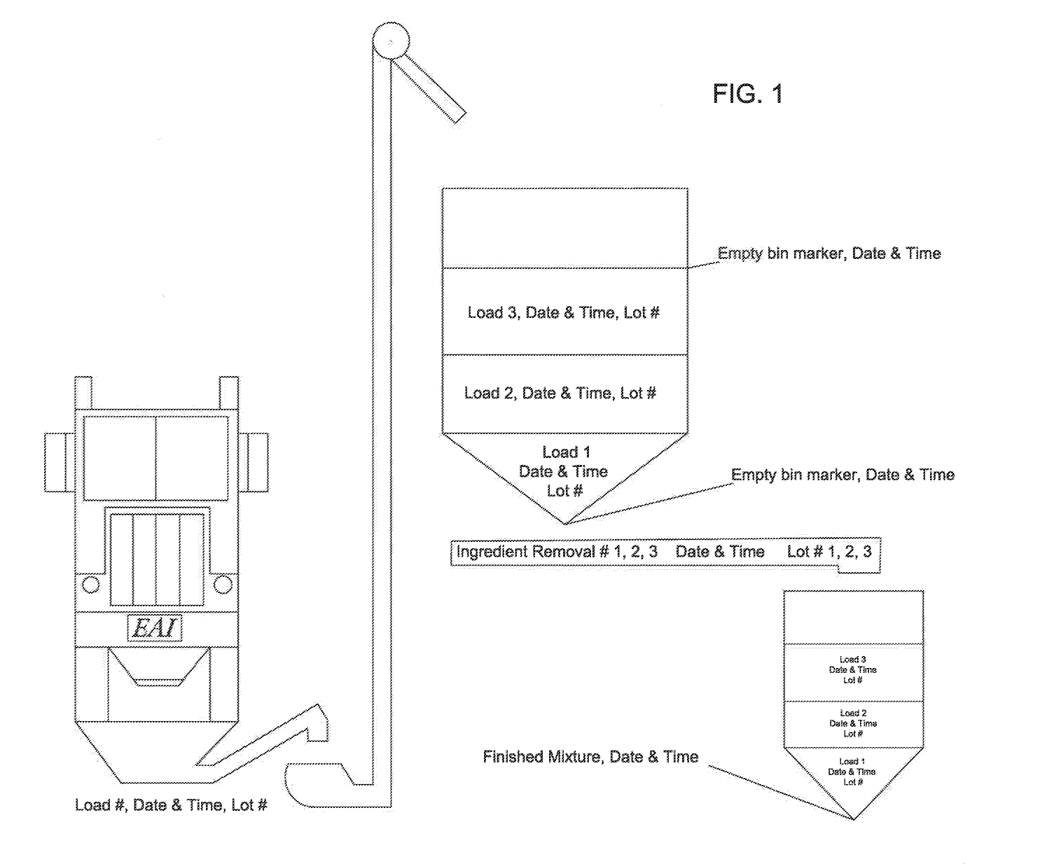

As can be seen by reference to the drawings, and in particular to FIG. 1, the method of tracking and tracing ingredients in a bulk holding bin that forms the basis of the present invention is generally illustrated.

The method of the present invention which solves the problems of the prior art is for the system to logically place into the computer database an empty bin indicator, including a resulting date and time whenever the silo becomes empty. As the user or the level sensor placed into the bin observe that the bin is empty, the system will store into a database that the bin was observed to be empty at this exact date and time.

Then as each subsequent truck load or delivery to the ingredient silo occurs, the inclusion of these ingredients into the ingredient silo or container will also include an entry into the computer database of the date and time of such addition of ingredients into the silo.

Each time ingredients are removed from the silo, the date and time of this removal will also be stored in the computer database.

Any removals of ingredients from the silo with a date and time removal that is between the empty bin markers for this bin placed into the computerized database could contain any particle of any truck load or other addition placed into the silo or container.

Thus, it is the capturing and reporting of all of the truck loads or other additions of ingredients received between the empty bin markers in the database that will yield a report of what particles of ingredients could possibly be in the mixture created by any ingredient leaving the silo between those same two times.

The end result is a perfect tracking and tracing of any particle of any ingredient into food or other industrial mixtures. This data will be often used for food safety reporting. If any truck load of ingredients is ever found to have been contaminated, one simple report from the database will show every single usage of the inventory into any animal feed or other mixture that could possibly contain an ingredient particle of the contaminated truck load.

To report any usage of a contaminated truck load, it would simply be a matter of reporting any mixture with an ingredient usage date and time from the affected silo after the inclusion of the contaminated truck load inventory addition, but up to or before the next empty bin marker in the database for that ingredient silo. If any animal or other species was found to have died or become ill from a poisoning from eating a feed or other mixture made by the system, a report could be made instantly showing any other mixture that could have been made from any particle contained in this mixture that had negatively affected the animal or species.

Such report would include looking also across the data from multiple ingredient silos or bins that happened to have been used in the mixture and observing the date and times where any mixture containing any of those ingredients contained in the contaminated mixture could have also been used.

Since the dates and times are stored in the computer database for every empty bin condition of the silo, every addition of any ingredient into the storage container silo, any use of any ingredient out of any container, and the identification and date and time of the resulting mixture containing any ingredient, a complete tracking report is possible.

The present invention is an invaluable solution to solving the problem of tracking and tracing ingredients relating animal feed for food safety and other mixtures of ingredients.

Ingredient information that is stored in the computer data base could include, but is not limited to, the name of the supplier, the purchase order number, the bill of lading number, the lot number of the ingredient, the truck number, the identification of the truck driver, the last commodity hauled in the truck, verification of whether or not the receiving system was flushed, and the net quantity of the ingredient received.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A method of tracking and tracing ingredients in a bulk holding bin, comprising the steps of:
determining a time when the bin is completely empty;
storing information relating to ingredients charged into the bin;
storing information relating to ingredients discharged from the bin;
determining a subsequent time when the bin is completely empty; and
using the stored information to determine the ingredients that could possibly be in a mixture discharged from the bin between the times when the bin is completely empty.

2. The method of claim 1, wherein the information relating to ingredients includes the ingredient lot number.

3. The method of claim 1, wherein the information relating to ingredients includes the quantity of the ingredient received.

4. The method of claim 1, wherein the information relating to ingredients includes the indicator of whether or not the ingredient receiving system was flushed.

5. The method of claim 1, wherein the information relating to ingredients includes the identification of the ingredient supplier.

6. The method of claim 1, wherein the information relating to ingredients includes the ingredient purchase order number.

7. The method of claim 1, wherein the information relating to ingredients includes the ingredient bill of lading number.

8. The method of claim 1, wherein the information relating to ingredients includes the ingredient delivery truck number.

9. The method of claim 1, wherein the information relating to ingredients includes the identification of the delivery truck driver.

10. The method of claim 1, wherein the information relating to ingredients includes the last commodity hauled in the delivery truck.
